(19) United States
(12) Patent Application Publication
(10) Pub. No.: US 2011/0038141 A1
(43) Pub. Date: Feb. 17, 2011

(54) LATERAL EMISSION LED BACKLIGHT FOR LCD

(76) Inventor: Martin David TILLIN, Oxon (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/538,954

(22) Filed: Aug. 11, 2009

(51) Int. Cl. G02F 1/13357

(52) U.S. Cl. 362/97.3

(57) ABSTRACT

A backlight for illuminating a liquid crystal display in which LEDs are arranged in an array in a backlight cavity. The LEDs are arranged such that the emission from the LEDs is in a lateral direction into the backlight cavity. The emission from the LEDs is shaped so as to match the cross-sectional shape of the backlight cavity thus achieving a high degree of spatial uniformity for a relatively small backlight cavity thickness.

### TECHNICAL FIELD

The present invention relates to a backlight for a Liquid Crystal Display (LCD) such as an LCD TV in which light is provided by Light Emitting Diodes (LEDs) which emit laterally into a backlight cavity.

### BACKGROUND TO THE INVENTION

LEDs are increasingly being used as light sources in backlights, and particularly for LCD TV. The LEDs may be used to illuminate the LCD panel directly, in which case they are placed in some form of array on a substrate. The substrate is placed some distance behind the LCD panel in order for light emitted by the LEDs to be mixed to achieve a good spatial uniformity. Films such as diffusers and Brightness Enhancement Films (BEFs) are usually placed at the rear of the LCD panel to achieve good directional uniformity and angular intensity profile. The space between the LED array and LCD panel and films defines the backlight cavity, which is usually covered in a reflective material to maximise light diffusion and re-circulation. In order to achieve good uniformity the cavity must be a thickness that is approximately equal to the lateral spacing of the LEDs in the array. It is known that the thickness of the backlight cavity can be reduced if the LEDs can be made to have a ‘batwing’ profile, that is, so that most of the light is emitted in a lateral direction. In this way, the path length of light emitted by the LED is increased and therefore spatial uniformity may be achieved for a thinner backlight cavity.

Such LEDs have been made by Lumileds and are disclosed in U.S. Pat. No. 6,679,621 in which an optical structure is placed above the emissive area of the LED. However, such optical structures are complicated and expensive to make and therefore are not commercially viable to be used in LCD backlights.

Various designs for the optic above the LED are known, for example, U.S. Pat. No. 7,387,399 discloses a reflecting optical element which can be used with a linear array of LEDs to redirect the light in a lateral direction.

An alternative is shown in U.S. Pat. No. 7,261,454 in which reflecting structures are placed directly above each LED with the effect of directing the light back towards the reflective coating on the rear substrate, or other features formed on the substrate, with the purpose of scattering light back towards the LCD panel. This arrangement also has the effect of increasing the path length of light emitted by the LED and subsequent light mixing.

In a similar way US 2006/0146530 A1 increases the path length of light emitted by the LED but without using any additional optical element on the LED. In this application the LEDs are placed at the top of the backlight cavity with light emitted in a downward direction towards the rear substrate. Features placed on the rear substrate redirects the light in a direction towards the LCD panel which, in addition to the scattering nature of the reflector achieves a good uniformity at the backlight films.

US 2008/0101086 A1 describes an alternative LED arrangement with no optical elements on the LED. In this case light is emitted in a lateral direction from the edges of the LED chip. Opaque metal is deposited on to the top of the LED to prevent light emission in a direction towards the LCD panel. Additional structure is provided on the rear substrate and at the top of the backlight cavity to scatter and redirect light towards the LCD panel.

U.S. Pat. No. 7,097,337 describes an alternative backlight arrangement for lateral emission which again requires the use of reflectors and lenses positioned in registration with the LEDs. The LEDs are arranged in a linear array on a circuit board and positioned so that the LEDs emit in a lateral direction. Cylindrical lenses are placed over each of the LEDs so as to spread light in a lateral direction, but the lenses provide no substantial modification to the emission profile in a vertical direction. The invention also provides for a reflector to be positioned behind each LED so as to modify the profile of the light that propagates into the backlight cavity. The shape of the reflector may be anisotropic so as to provide a different propagation profile in a vertical and horizontal direction.

### SUMMARY OF THE INVENTION

A first aspect of the present invention provides a LCD backlight comprising: LEDs arranged to emit light in a substantially lateral direction; a LCD panel, which may include diffusers and brightness enhancing films; a reflector to redirect light towards the LCD panel; a cavity between the LCD and the reflector.

For example, the LEDs may be of a conventional type, i.e. emitting light in a direction substantially perpendicular to the multiple quantum wells (MQW), but with the package of the LEDs rotated so as to arrange for the light to be emitted into the thickness of the backlight cavity. The LEDs may be rotated so that the emission direction is more towards the reflector than the LCD panel.

The LEDs may be arranged in rows so that the emission from one LED is substantially towards the rear of the LED package in front.

Adjacent rows of LEDs may be arranged to emit in opposite directions. The rows of LEDs may be offset with respect to adjacent rows so as to fill spaces between LEDs with a substantially uniform light flux.

The LEDs may be designed to emit light of any colour. The LED may emit white light or a single colour such as blue. The LED may be designed to emit white through the use of a yellow phosphor on top of a blue emitter, or it may be designed to emit white light through the combination of separate red, green and blue emitters packaged together in a single LED package.

According to another aspect of this invention, the LEDs are arranged to have an emission profile that is asymmetric such that the angular half width of emission in a vertical direction (thickness of the backlight cavity) is less than in a lateral direction (in the plane of the backlight cavity). Ideally the emission profile should be matched to the cross-section of the backlight cavity. The emission profile is shaped at the chip level rather than through the use of an external optical element. This may be achieved by the addition of photonic structures to the LED chip. The photonic structure may be a 1-dimensional photonic crystal arranged with lattice vector to be substantially parallel to the normal to the backlight cavity. Alternatively the photonic structure may be a 2-dimensional photonic structure with different lattice vectors in orthogonal directions such that the emission profile is narrowed in the vertical direction, but widened in the direction parallel to the backlight cavity.

According to another aspect of this invention, the reflector may be shaped so as to maximise the amount of light redirected towards the LCD panel. The reflector may have an elliptical shape.

According to another aspect of this invention, the reflector may include light turning elements so as to maximise redirection of light towards the LCD panel.

According to another aspect of this invention, the LED packages are surface mounted to circuit boards placed beneath the reflector.

According to another aspect, a backlight for a transmissive display having a transmissive display panel is provided. The backlight includes an array of light sources arranged generally parallel to the display panel; and a reflector generally parallel to the array of light sources on a side thereof opposite the display panel, the reflector and the display panel defining a backlight cavity therebetween. Each of the light sources includes a light emitting diode configured to emit light within the backlight cavity in a lateral direction away from normal to the display panel, and that has an emission profile in which the angular half width of emission in a plane normal to the display panel is narrower than that of a Lambertian profile.

In accordance with another aspect, the emission profile of each of the light emitting diodes in a plane parallel to the display panel is Lambertian.

In accordance with another aspect, the emission profile of each of the light emitting diodes in a plane parallel to the display panel is wider than that of a Lambertian profile.

According to another aspect, the intensity of light emitted by the light emitting diodes in the plane normal to the display panel is approximately in proportion to a distance the light travels before striking a reflective or scattering surface within the backlight cavity.

According to another aspect, each of the light emitting diodes includes a photonic structure for shaping the emission profile thereof.

In accordance with another aspect, the photonic structure is a one-dimensional photonic structure.

According to still another aspect, the photonic structure is a two-dimensional photonic structure.

In accordance with yet another aspect, the photonic structure has a different lattice constant in orthogonal directions.

According to another aspect, the photonic structure is a photonic crystal or quasi-photonic crystal.

According to another aspect, the light emitting diodes are arranged in rows.

In accordance with another aspect, in a given row the emission from one light emitting diode is directed substantially towards the rear of another light emitting diode in front.

According to yet another aspect, adjacent rows of light emitting diodes are arranged so as to emit light in opposite directions.

According to another aspect, adjacent rows of light emitting diodes are shifted laterally with respect to one another.

In accordance with another aspect, the reflector includes light turning elements which function to turn light incident thereon towards the display panel.

According to another aspect, the light turning elements include portions of the reflector having an elliptical profile between the light emitting diodes.

According to another aspect, the light turning elements include rear portions of packages housing the respective light emitting diodes.

In yet another aspect, packages housing the respective light emitting diodes are surface mounted to a circuit board positioned beneath the reflector.

In still another aspect, a backlight for a transmissive display having a transmissive display panel is provided. The backlight includes an array of light sources arranged generally parallel to the display panel; and a reflector generally parallel to the array of light sources on a side thereof opposite the display panel, the reflector and the display panel defining a backlight cavity therebetween. Each of the light sources includes a light emitting diode having a generally Lambertian emission profile at least in a plane normal to the display panel, and a primary emission direction of the light emitting diode within the plane is at an angle that is non-normal and non-parallel to the display panel.

According to another aspect, the primary emission direction is towards the reflector.

According to another aspect, the primary emission direction is towards the display panel.

In accordance with still another aspect, each of the light emitting diodes includes a light emitting area normal to which defines the primary emission direction.

According to still another aspect, packaging of each of the light emitting diodes conventionally used to mount the light emitting diode such that the light emitting area is either normal or parallel to the display panel is instead rotated relative thereto.

In accordance with another aspect, the primary emission direction is at an angle of either 95-140 degrees or 40-85 degrees from normal to the display panel.

According to another aspect, the primary emission direction is at an angle of either 100-120 degrees or 60-80 degrees from normal to the display panel.

In accordance with yet another aspect, the light emitting diodes are arranged in rows.

According to another aspect, in a given row the emission from one light emitting diode is directed substantially towards the rear of another light emitting diode in front.

In accordance with another aspect, adjacent rows of light emitting diodes are arranged so as to emit light in opposite directions.

According to another aspect, adjacent rows of light emitting diodes are shifted laterally with respect to one another.

According to still another aspect, the reflector includes light turning elements which function to turn light incident thereon towards the display panel.

In accordance with another aspect, the light turning elements include portions of the reflector having an elliptical profile between the light emitting diodes.

According to another aspect, the light turning elements include rear portions of packages housing the respective light emitting diodes.

In accordance with another aspect, packages housing the respective light emitting diodes are surface mounted to a circuit board positioned beneath the reflector.

It is thus possible to provide a backlight for a LCD which allows for thinner LCD TVs but with very good uniformity of illumination. The backlights using the arrangements described may also be lower power and have a lower component cost than equivalent directly illuminated LED backlights.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Embodiments of the invention will be further described, by way of example, with reference to the accompanying drawings, in which:

FIG. 1 is a diagram illustrating an embodiment of the current invention in which FIG. 1(a) is a cross section of a backlight and FIG. 1(b) is a plan view of the backlight;

FIG. 2 is a cross-sectional diagram illustrating a surface mounting of LEDs to a circuit board placed beneath a reflector;

FIG. 3 is a diagram illustrating a second embodiment of the current invention in which FIG. 3(a) is a cross section of a backlight and FIG. 3(b) is a plan view of the backlight;

FIG. 4 is a diagram illustrating a cross-section of a LED;

FIG. 5 is a graph of intensity against angle for 2 orthogonal directions of emission from an LED;

FIG. 6 is a cross-sectional diagram illustrating a third embodiment of the invention;

FIG. 7 is a cross-sectional diagram illustrating a fourth embodiment of the invention;

FIG. 8 is a cross-sectional diagram illustrating a fifth embodiment of the invention; and

FIG. 9 is a diagram illustrating an embodiment of the invention in which FIG. 9(a) is a cross section of a backlight and FIG. 9(b) is a plan view of the backlight.

### DETAILED DESCRIPTION OF THE INVENTION

The present invention will now be described with reference to the drawings in which like reference numerals are used to refer to like elements.

### Embodiment 1

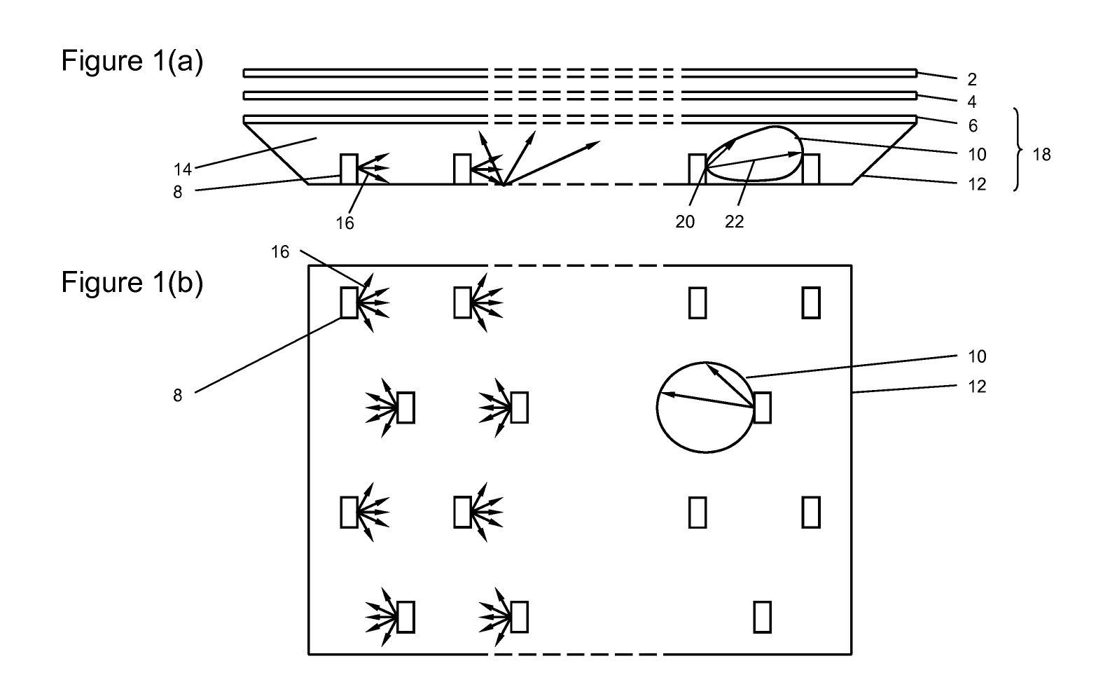

FIG. 1(a) shows a cross-section of a backlight unit 18, comprising LEDs 8, arranged in a regular array, a reflector 12, a light diffusion plate 6, and a cavity 14. The LEDs 8 are placed above a reflector 12. Some distance above the reflector 12 there is a diffuser 6, the purpose of which is to homogenise the light emitted by the LEDs 8; the diffuser may also provide some beam shaping functions, for example by the inclusion of optical features such as may be found on Brightness Enhancement Films (BEFs). Above the diffuser 6 is placed a Liquid Crystal Display (LCD) panel 2 that is to be illuminated by the backlight unit 18. Additional films 4 may be placed between the backlight unit 18 and the LCD 2. The function of these films 4 is to provide further light shaping of the light emitted by the backlight unit 18. The films may comprise BEFs, light shaping diffusers, and reflective polarisers such as the Dual Brightness Enhancement Film (DBEF), made by 3M.

The LEDs 8 are positioned such that the emission from the LED, as shown schematically by the arrows 16 is substantially laterally into the cavity 14. Ideally the emission profile from the LEDs 8 is non-Lambertian. For example, preferably the emission profile from the LEDs 8 has a half-width in the plane normal to the display panel on the order of less than ±40 degrees, whereas a Lambertian profile is ±60 degrees. This is shown schematically by the polar emission profile 10, in which the length of the arrow from the point of emission 20 on the LED 8 to the perimeter of the polar emission profile 10 is representative of the intensity of the light emitted in the direction indicated by the arrow 22. A Lambertian emission from the LED 8 would be represented by a circular polar emission profile. In this embodiment the emission from the LED 8 is arranged such that the intensity of the emission from the LED 8 is enhanced in the direction normal to the emitting area 22 i.e. laterally into the backlight cavity 14, but reduced in directions towards the diffuser 6 and the reflector 12. In this way the path length of the light is increased before it strikes the diffuser 6, resulting in greater spatial uniformity at the diffuser than if the light had been emitted directly towards the diffuser.

The emission profile of the LEDs 8 in the plane normal to the display preferably is shaped such that the intensity of the light is approximately in proportion to the distance the light travels before striking a reflective or scattering surface within the backlight cavity. This will aid in maximizing uniformity within the backlight as will be appreciated.

FIG. 1(b) shows a plan view of the same backlight unit 18, but without the diffuser 6. The LEDs 8 are preferentially arranged in rows such that the emission from one LED 8 is substantially towards the rear of the next LED 8 in the linear array. Adjacent rows of LEDs 8 are arranged to be substantially parallel to each other. Preferably, adjacent rows of LEDs 8 are arranged so as to emit in opposite directions. Preferably, adjacent rows of LEDs 8 are shifted laterally with respect to one another such that the intensity of the emitted light indicated by the arrows 16 may be understood to give the most uniform distribution of light in the backlight unit cavity 14. Preferably the polar emission profile 10 from the LED 8 is Lambertian in this plane, as indicated by the circle.

By arranging the LEDs 8 in linear arrays it is possible to control each line of the array separately so as to locally dim regions of the backlight in correspondence to what ever picture is displayed on the LCD panel. This is a well-known technique in the prior art for achieving enhanced picture contrast and is known by various names, for example area dimming or sequential scanning. This invention would be particularly suited to sequential scanning, in which lines of LEDs could be activated in a sequential manner such that a line of illumination is scanned down or across the LCD panel to achieve better moving image picture quality.

The emission profile of the LED may be made asymmetric in this way through the use of photonic structures either formed in the LED chip itself, or in an over-layer that is adhered to the chip during manufacture.

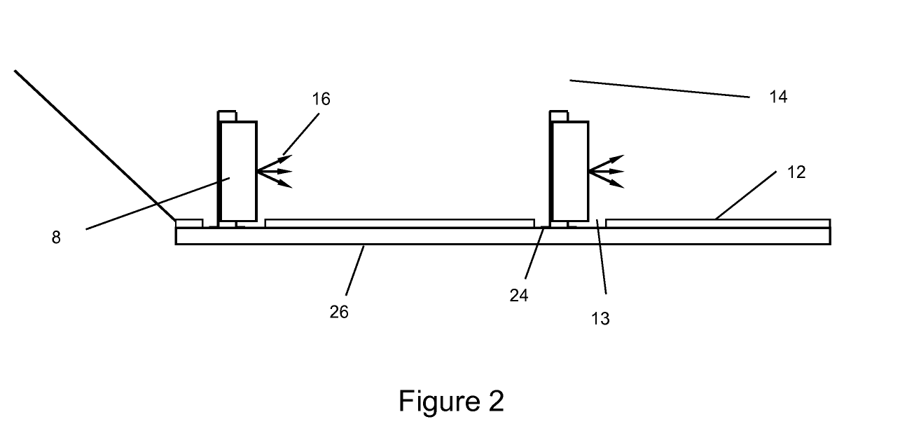

The LEDs 8 may be made to emit in a lateral direction into the backlight cavity 14 by rotating the LED package through 90 degrees from the conventional arrangement. In this case the LED package is modified such that electrical contacts to the LED chip are arranged to emerge from the lower surface of the package that is adjacent to the reflector 12. One such arrangement is shown in FIG. 2, in which electrical contacts 24 are arranged to make electrical contact with a circuit board 26 placed beneath the reflector 12, such that the LED 8 may be surface mounted to the circuit board, 26, typically through a hole in the reflector 13. Thus the array of LEDs 8 may be easily manufactured into the backlight unit 18.

### Embodiment 2

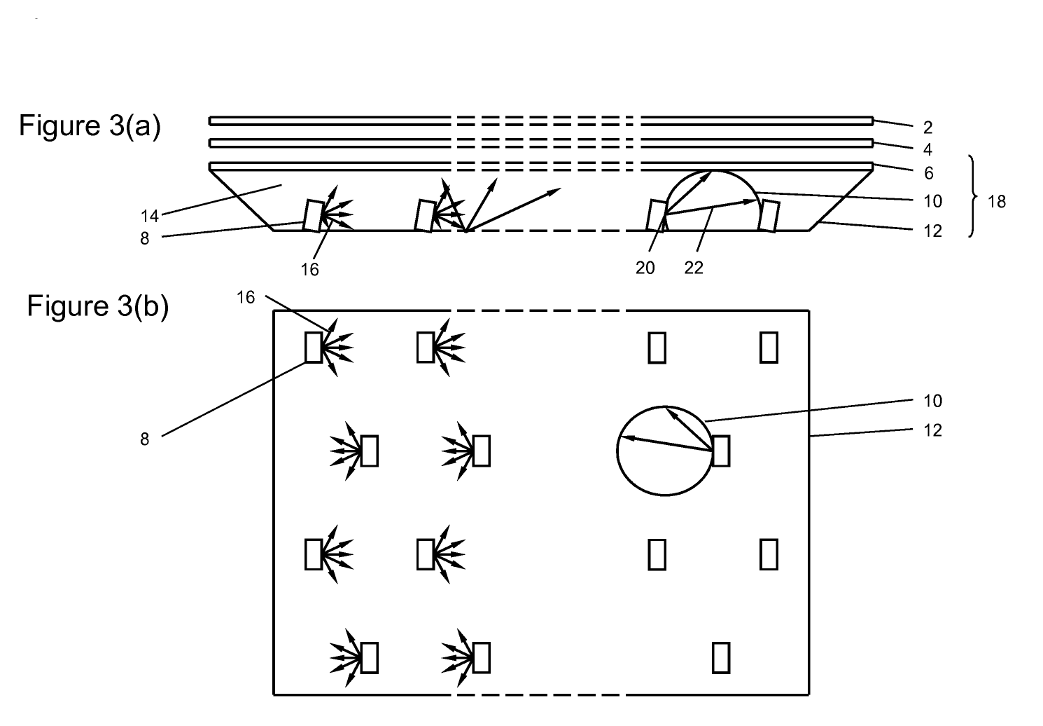

In this embodiment the LEDs 8 used have a Lambertian emission profile. Despite not having an emission profile which has been modified as described hereinbefore, it is possible to reduce the thickness of the backlight cavity 14, yet maintaining good spatial uniformity of light at the diffuser, 6. The LEDs 8 are arranged as described above, but now the package is rotated slightly towards the rear reflector 12 as shown in FIGS. 3(a) and 3(b). The polar emission profile 10 now has a shape that is circular (before it intersects with any of the other components of the backlight unit). The effect of rotating the package so that the primary emission direction (normal to the emitting area 20) is at an angle of 95 degrees to 140 degrees from normal to the display panel 2, and preferably 100 degrees to 120 degrees, is that more light is directed back towards the reflector 12 and less light directly illuminates the diffuser 6. Consequently, the light path of the light emitted by the LEDs 8 is increased over the conventional situation. The result is that good spatial uniformity can be achieved for a reduced backlight cavity thickness.

In the event it is desirable to reduce the light path of the light emitted by the LEDs, one instead may rotate the package of the LEDs slightly towards the display panel 12 as will be appreciated. For example, the package may be rotated such that the primary emission direction (normal to the emitting area 20) is at an angle of 40 degrees to 85 degrees from normal to the display panel 2, and preferably 60 degrees to 80 degrees.

The LEDs 8 may be of a conventional type, i.e., emitting light in a direction substantially perpendicular to the multiple quantum wells (MQW). Thus, by simply rotating the package of the respective LEDs 8 the primary direction of the otherwise Lambertian profile is towards or away from the reflector 12.

### Embodiment 3

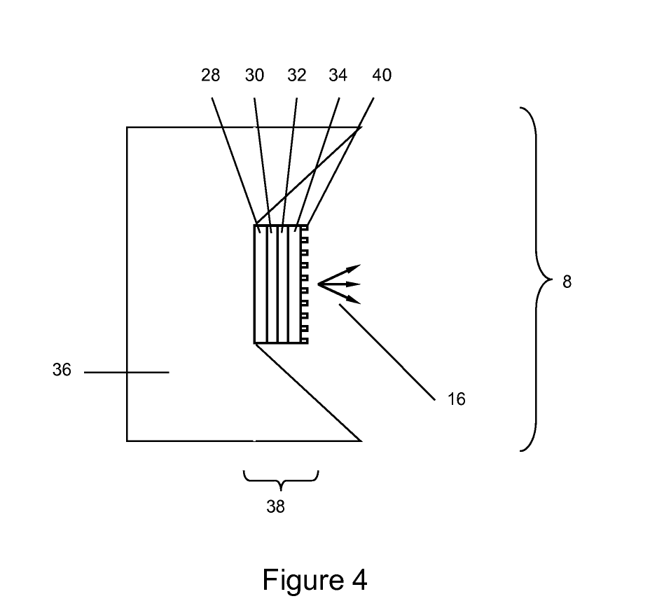

As mentioned hereinbefore, the emission profile of the LED 8 may be made asymmetric through the use of photonic structures either formed in the LED chip itself, or in an over-layer that is adhered to the chip during manufacture. The emission profile of the LED 8 may be modified in one direction only, for example, through the use of a 1-dimensional diffraction grating which has been imprinted into the semiconductor material. This is schematically shown in FIG. 4, which shows an exemplary LED 8 including a package 36 and an LED chip 38. The LED chip 38 includes a substrate 28, multi-quantum well region 32, n-type or p-type region 30, and p-type or n-type region 34, in which a photonic structure 40, has been formed. Alternatively, the photonic structure 40 could be imprinted into an overlayer, for example, a photoresist material which has been coated onto the LED chip 38, or an encapsulant that is used to seal the LED package.

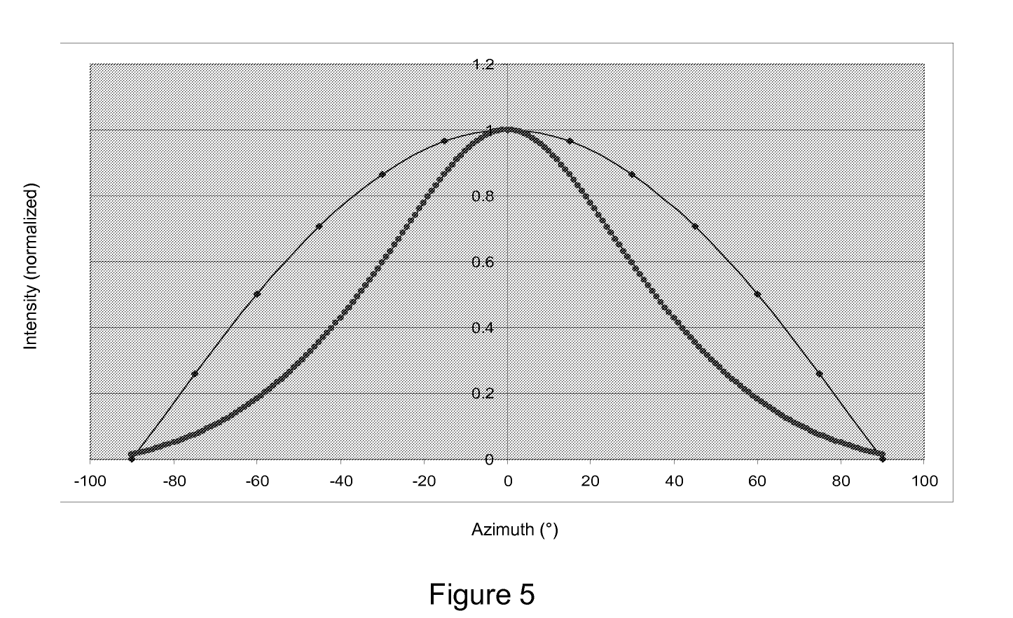

In one example, a diffraction grating with a pitch of 400 nm was imprinted into a GaN LED which had a peak emission wavelength of 460 nm, by Nano-Imprint Lithography (NIL). NIL is a standard technique well-known in the art for forming sub-micron sized features in opto-electronic devices. For example, a layer of photoresist may be applied to the GaN device and a master stamp with a defined profile is pressed into the photoresist to leave an imprint of the pattern in the photoresist. It is desirable to achieve the thinnest possible residual layer of photoresist where the features of the stamp have been pressed into the photoresist. The inverse structure of the master stamp may then be etched into GaN material through the use of ICP etching. Once the photoresist has been removed then the device bears an inverse pattern of the master stamp in its surface. The resulting emission profile from the LED made in such a fashion had a full-width half maximum (FWHM) of less than 60 degrees (a Lambertian emission would have a FWHM of 120 degrees) in one direction, but 120 degrees in the orthogonal direction, as shown in normalised intensity profiles in FIG. 5. The LED was arranged in a backlight unit as described hereinbefore such that the direction with the smaller FWHM was substantially normal to the plane of the backlight cavity 14. The result was that the backlight cavity 14 thickness could be reduced from 24 mm to a thickness of less than 18 mm for an LED pitch in a line of LEDs of 22 mm.

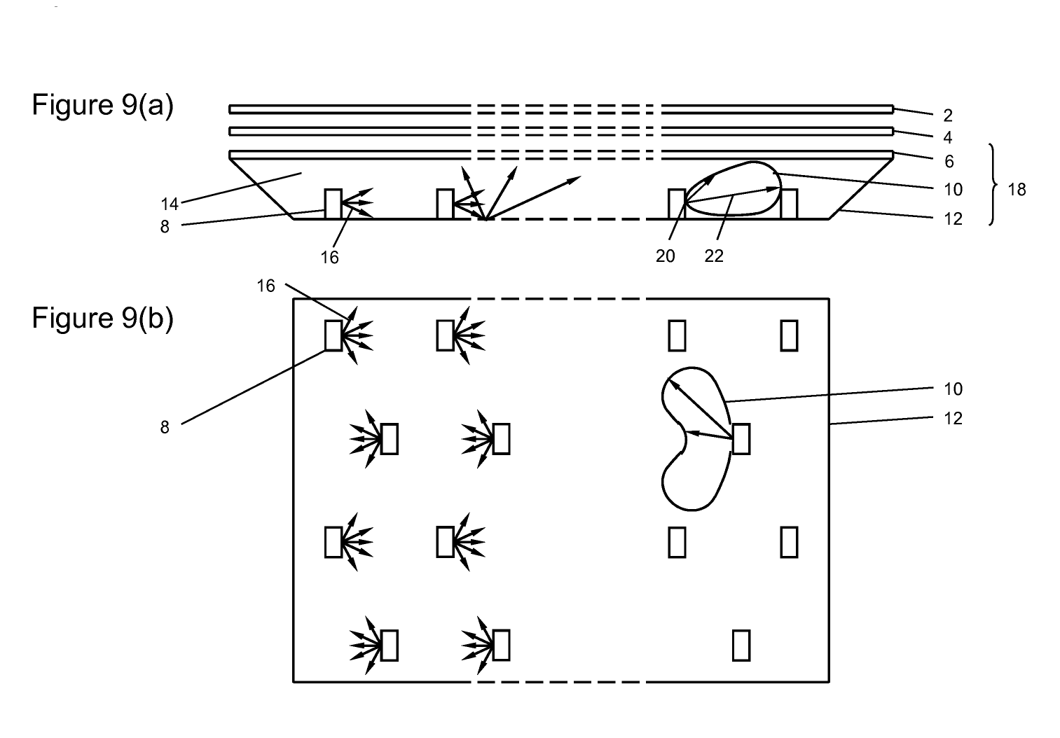

The LED emission profile may also be modified in 2 directions through the use of a 2-dimensional photonic structure. Such a 2-dimensional photonic structure may be a photonic crystal comprising a series of holes formed in the top layer of the semi-conductor material. Such a photonic crystal may be formed by NIL processing into p- or n-type doped semiconductor. The photonic crystal may extend in depth to close to the multi-quantum well region of the LED 8. Alternatively the photonic structure may be a quasi-photonic crystal structure in which the structure has a long range order, but no regular short range order. The advantage of using a 2-dimensional photonic structure is that the emission profile may be reduced in one direction, as described hereinbefore, but it may also be widened in the orthogonal direction through a suitable choice of lattice constant which is different to that used in the orthogonal direction (see, e.g., FIGS. 9(a)-9(b)). For example, a 2-dimensional photonic crystal was fabricated which had a pitch in one direction of 400 nm and a pitch in the orthogonal direction of 300 nm. The GaN LED had a peak emission wavelength of 460 nm. The resulting emission profile from the LED had a FWHM of 60 degrees in one direction and greater than 130 degrees in the orthogonal direction. The advantage of this arrangement is that high spatial uniformity can be achieved at the diffuser, 6, for an even greater reduction in backlight cavity thickness. The result in this case is that the backlight cavity thickness could be reduced from 24 mm to 16 mm for an LED pitch of 22 mm.

Although the description hereinbefore is concerned with single colour LEDs 8, the actual colour or type of LED 8 used is not limiting to the scope of the invention and any colour of light or broad coverage of the LED spectrum can be achieved. For example, in order to make a white LED from a GaN blue emitter it is simply required to incorporate a yellow phosphor into the structure at the appropriate place and with the optimum quantity of phosphor to give a balanced white. If a photonic structure is to be incorporated into the LED 8 structure then it could be formed directly into the phosphor layer itself.

An alternative method of producing white emission is to combine one or more emitters of different colours into the LED package 36. For example, it would be easy to provide for a single red, green and blue emitter to be incorporated into a single LED package. In this case, the intensity of each of the different colours can be controlled to achieve a particular colour provided that separate electrical connection is made to each of the LED chips.

### Embodiment 4

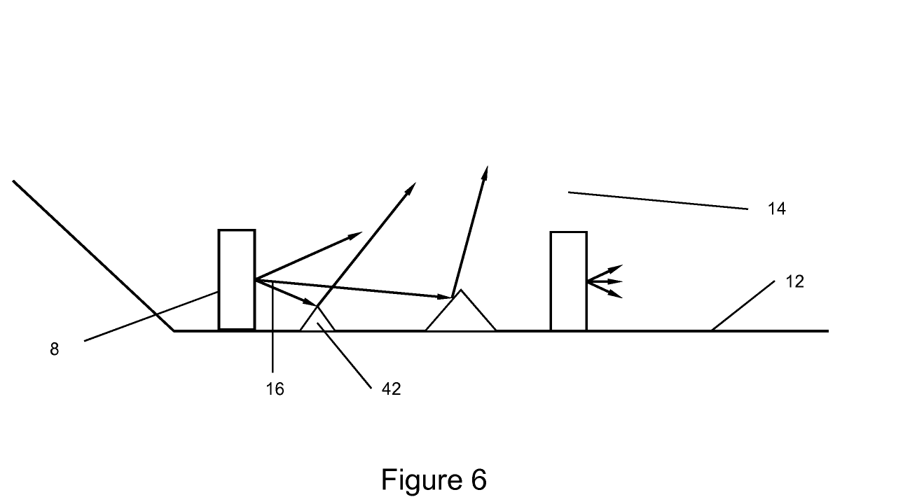

The reflector 12 in this invention may be planar with a plane that is parallel to the backlight cavity 14. In this case the reflector 12 is likely to be highly scattering so that light can be efficiently re-directed towards the LCD panel 2. Alternatively the reflector 12 may be shaped to aid the re-direction of light towards the LCD panel 2. One way in which this may be accomplished is shown in FIG. 6, in which light turning elements 42 are added to the reflector 12. These may be of any size, either microscopic to scatter the emitted light 16, or macroscopic refractive, reflective, or covered in some form of scattering medium.

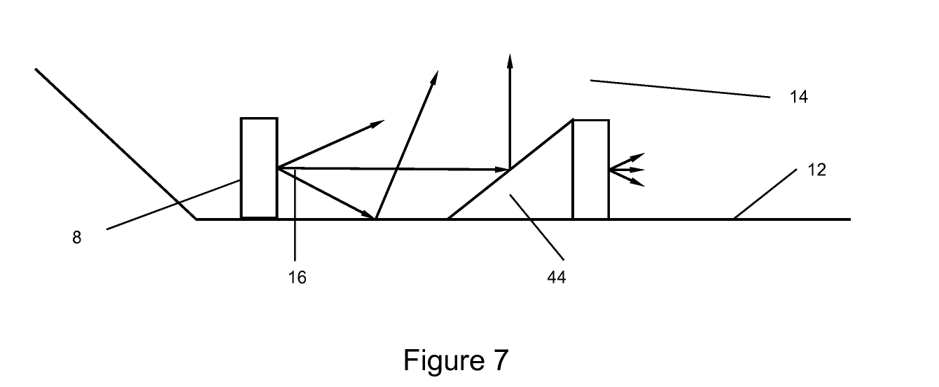

An alternative embodiment is shown in FIG. 7, in which the LED 8 is modified so that the package is extended at the rear towards the preceding LED in the line of LEDs. The extended portion 44 of the package may be planar and reflecting or scattering, or it may be curved so as to re-direct the light in a preferential direction.

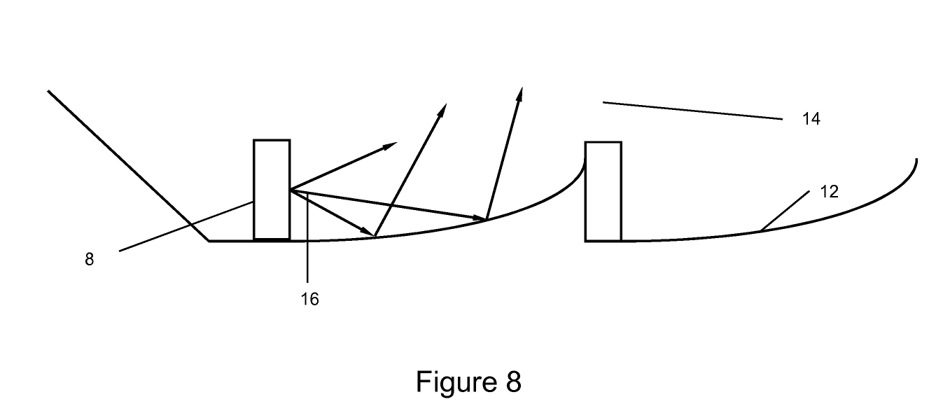

In an alternative embodiment, the reflector 12 is shaped in an elliptical profile as illustrated in FIG. 8. The advantage of this arrangement is that the light is turned through a substantially larger angle than may be achieved with a purely scattering reflector, such that the diffuser 6 may be formed of a slightly weaker diffusing material.

It will be noted by anyone skilled in the art that special attention may need to be paid at the edges of the backlight in order to achieve a uniform illumination around the perimeter. The backlight cavity may be varied at a local level to ensure that the spatial uniformity at the diffuser is maintained. Alternatively the intensity of the LEDs around the edge may be individually adjusted to take account of this. Alternatively, additional LEDs can be provided on a different pitch to fill areas in which the light flux is lower. Alternatively, the emission profile of individual LEDs around the perimeter may be adjusted to achieve good spatial uniformity.

It is the intention that the invention is not limited to the specific embodiments and examples given above, and that others will be obvious to anyone skilled in the art.

1. A backlight for a transmissive display having a transmissive display panel, the backlight comprising:
an array of light sources arranged generally parallel to the display panel; and
a reflector generally parallel to the array of light sources on a side thereof opposite the display panel, the reflector and the display panel defining a backlight cavity therebetween,
wherein each of the light sources comprises a light emitting diode configured to emit light within the backlight cavity in a lateral direction away from normal to the display panel, and that has an emission profile in which the angular half width of emission in a plane normal to the display panel is narrower than that of a Lambertian profile.

2. The backlight according to claim 1, wherein the emission profile of each of the light emitting diodes in a plane parallel to the display panel is Lambertian.

3. The backlight according to claim 1, wherein the emission profile of each of the light emitting diodes in a plane parallel to the display panel is wider than that of a Lambertian profile.

4. The backlight according to claim 1, wherein the intensity of light emitted by the light emitting diodes in the plane normal to the display panel is approximately in proportion to a distance the light travels before striking a reflective or scattering surface within the backlight cavity.

5. The backlight according to claim 1, wherein each of the light emitting diodes comprises a photonic structure for shaping the emission profile thereof.

6. The backlight according to claim 5, wherein the photonic structure is a one-dimensional photonic structure.

7. The backlight according to claim 5, wherein the photonic structure is a two-dimensional photonic structure.

8. The backlight according to claim 7, wherein the photonic structure has a different lattice constant in orthogonal directions.

9. The backlight according to claim 5, wherein the photonic structure is a photonic crystal or quasi-photonic crystal.

10. The backlight according to claim 1, wherein the light emitting diodes are arranged in rows.

11. The backlight according to claim 10, wherein in a given row the emission from one light emitting diode is directed substantially towards the rear of another light emitting diode in front.

12. The backlight according to claim 10, wherein adjacent rows of light emitting diodes are arranged so as to emit light in opposite directions.

13. The backlight according to claim 10, wherein adjacent rows of light emitting diodes are shifted laterally with respect to one another.

14. The backlight according to claim 1, wherein the reflector comprises light turning elements which function to turn light incident thereon towards the display panel.

15. The backlight according to claim 14, wherein the light turning elements comprise portions of the reflector having an elliptical profile between the light emitting diodes.

16. The backlight according to claim 14, wherein the light turning elements comprise rear portions of packages housing the respective light emitting diodes.

17. The backlight according to claim 1, wherein packages housing the respective light emitting diodes are surface mounted to a circuit board positioned beneath the reflector.

18. A backlight for a transmissive display having a transmissive display panel, the backlight comprising:
an array of light sources arranged generally parallel to the display panel; and
a reflector generally parallel to the array of light sources on a side thereof opposite the display panel, the reflector and the display panel defining a backlight cavity therebetween,
wherein each of the light sources comprises a light emitting diode having a generally Lambertian emission profile at least in a plane normal to the display panel, and a primary emission direction of the light emitting diode within the plane is at an angle that is non-normal and non-parallel to the display panel.

19. The backlight according to claim 18, wherein the primary emission direction is towards the reflector.

20. The backlight according to claim 18, wherein the primary emission direction is towards the display panel.

21. The backlight according to claim 18, wherein each of the light emitting diodes comprises a light emitting area normal to which defines the primary emission direction.

22. The backlight according to claim 21, wherein packaging of each of the light emitting diodes conventionally used to mount the light emitting diode such that the light emitting area is either normal or parallel to the display panel is instead rotated relative thereto.

23. The backlight according to claim 18, wherein the primary emission direction is at an angle of either 95-140 degrees or 40-85 degrees from normal to the display panel.

24. The backlight according to claim 18, wherein the primary emission direction is at an angle of either 100-120 degrees or 60-80 degrees from normal to the display panel.

25. The backlight according to claim 18, wherein the light emitting diodes are arranged in rows.

26. The backlight according to claim 25, wherein in a given row the emission from one light emitting diode is directed substantially towards the rear of another light emitting diode in front.

27. The backlight according to claim 25, wherein adjacent rows of light emitting diodes are arranged so as to emit light in opposite directions.

28. The backlight according to claim 25, wherein adjacent rows of light emitting diodes are shifted laterally with respect to one another.

29. The backlight according to claim 18, wherein the reflector comprises light turning elements which function to turn light incident thereon towards the display panel.

30. The backlight according to claim 29, wherein the light turning elements comprise portions of the reflector having an elliptical profile between the light emitting diodes.

31. The backlight according to claim 29, wherein the light turning elements comprise rear portions of packages housing the respective light emitting diodes.

32. The backlight according to claim 18, wherein packages housing the respective light emitting diodes are surface mounted to a circuit board positioned beneath the reflector.
